(19) United States
(12) Patent Application Publication
(10) Pub. No.: US 2015/0209224 A1
(43) Pub. Date: Jul. 30, 2015

(54) HEATING APPARATUS TO GENERATE STEAM BY HEATING WATER

(71) Applicant: U YOUNG APPLIANCE MANUFACTURING (XIAMEN) CO., LTD., Xiamen City (CN)

(72) Inventor: Chihming HSU, Douliu City (TW)

(21) Appl. No.: 14/287,688

(22) Filed: May 27, 2014

(30) Foreign Application Priority Data
Jan. 28, 2014 (CN) 201410041559.9

(51) Int. Cl. A61H 33/12; F22B 1/28

(52) U.S. Cl. CPC A61H 33/12; F22B 1/284

(57) ABSTRACT

A heating apparatus to generate steam by heating water includes a silicone mask, a mask seat, an upper base cover, a seal ring, and a lower base cover. The upper base cover has an inner cavity and an outer cavity therein. The inner cavity is adapted to accommodate heating water. The outer cavity is adapted to accommodate supply water. A gap is formed between the inner cavity and the outer cavity for the supply water to flow into the inner cavity. The heating water in the inner cavity is heated by a heating member disposed under the inner cavity to generate steam. The steam enters the mask seat through an adjustment plate disposed above the inner cavity. The present invention not only shortens the time to heat the water but also saves the power to enhance the work efficiency. The service life of the product is prolonged.

### BACKGROUND OF THE INVENTION

1. Field of the Invention

The present invention relates to a heating apparatus to generate steam by heating water.

2. Description of the Prior Art

In recent years, a cosmetic method to blow steam toward the facial skin is widely used at beauty parlors. The steam infiltrates the skin cell, and then the skin cell is expanded to eliminate the aging skin attached to the skin so as to improve dry skin, such that the skin is moist and has elasticity. Steam makes the pores in the skin open, which is beneficial to clean the deep dirt in the hair follicles and to enhance the blood circulation and metabolism of the skin. This makes the skin exquisite and rosy. However, the existing steam generator has a complicated structure. The time to heat the water is long and the steam is generated slowly to cause a waste of energy. Accordingly, the inventor of the present invention has devoted himself based on his many years of practical experiences to solve these problems.

### SUMMARY OF THE INVENTION

The primary object of the present invention is to provide a heating apparatus to generate steam by heating water to shorten the heating time and save the power.

In order to achieve the aforesaid object, the heating apparatus of the present invention comprises a silicone mask, a mask seat, an upper base cover, a seal ring, and a lower base cover. The upper base cover has an inner cavity and an outer cavity therein. The inner cavity is adapted to accommodate heating water. The outer cavity is adapted to accommodate supply water. A gap is formed between the inner cavity and the outer cavity for the supply water to flow into the inner cavity. The heating water in the inner cavity is heated by a heating member disposed under the inner cavity to generate steam. The steam enters the mask seat through an adjustment plate disposed above the inner cavity.

Preferably, the outer cavity surrounds the inner cavity and is disposed in the upper base cover.

Preferably, the heating member is a PTC (positive temperature coefficient) heating member.

Preferably, a plurality of rubber pads are provided under the lower base cover.

The present invention not only shortens the time to heat the water but also saves the power to enhance the work efficiency. Furthermore, the cool water in the outer cavity provides heat insulation and protection functions for the inner cavity, so that the service life of the product can be prolonged.

### BRIEF DESCRIPTION OF THE DRAWINGS

FIG. 1 is a schematic view according to a preferred embodiment of the present invention.

### DETAILED DESCRIPTION OF THE PREFERRED EMBODIMENTS

Embodiments of the present invention will now be described, by way of example only, with reference to the accompanying drawings.

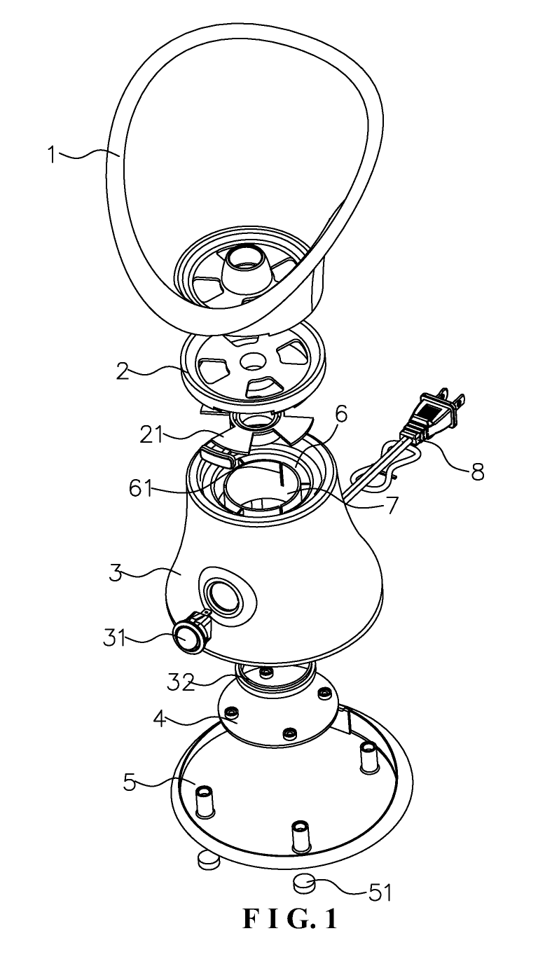

As shown in FIG. 1, the present invention discloses a heating apparatus to generate steam by heating water. The heating apparatus comprises a silicone mask 1, a mask seat 2, an upper base cover 3, a seal ring 32, and a lower base cover 5. The upper base cover 3 has an inner cavity 6 and an outer cavity 7 therein. The inner cavity 6 is adapted to accommodate heating water, and the outer cavity 7 is adapted to accommodate supply water. In this embodiment, the outer cavity 7 surrounds the inner cavity 6 and is disposed in the upper base cover 3. A gap 61 is formed between the inner cavity 6 and the outer cavity 7 for the supply water to flow into the inner cavity. The heating water in the inner cavity 6 is heated by a heating member disposed under the inner cavity 6 to generate steam. In order to enhance the heating effect and for the purposes of health and environmental protection, this embodiment uses a PTC (positive temperature coefficient) heating member 4. The seal ring 32 is disposed above the PTC heating member 4, so that the heat won't radiate. The steam enters the mask seat 2 through an adjustment plate 21 disposed above the inner cavity 6. In order to provide a backing and buffer protection function for the heating apparatus, this embodiment is provided with a plurality of rubber pads 51 under the lower base cover 5.

When in use, the inner cavity 6 and the outer cavity 7 of the upper base cover 3 are filled with water. After a power cord 8 is plugged to start a rocket switch 31, the water in the inner cavity 6 is heated by the PTC heating member 4. The water in the outer cavity 7 keeps the same temperature. The water in the outer cavity 7 is cooler than that of the inner cavity 6 so as to provide heat insulation and protection functions. When the heating water in the inner cavity 6 is evaporated to generate steam to enter the mask seat 2 through the adjustment plate 21, the heating water in the inner cavity 6 will decrease. The supply water in the outer cavity 7 will flow to the inner cavity 6 through the gap 61 to ensure the volume of the water in the inner cavity 6.

The present invention not only shortens the time to heat the water but also saves the power to enhance the work efficiency. Furthermore, the cool water in the outer cavity provides heat insulation and protection functions for the inner cavity 6, so that the service life of the product can be prolonged.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A heating apparatus to generate steam by heating water, comprising a silicone mask, a mask seat, an upper base cover, a seal ring, and a lower base cover, the upper base cover having an inner cavity and an outer cavity therein, the inner cavity being adapted to accommodate heating water, the outer cavity being adapted to accommodate supply water, a gap being formed between the inner cavity and the outer cavity for the supply water to flow into the inner cavity, the heating water in the inner cavity being heated by a heating member disposed under the inner cavity to generate steam, the steam entering the mask seat through an adjustment plate disposed above the inner cavity.

2. The heating apparatus as claimed in claim 1, wherein the outer cavity surrounds the inner cavity and is disposed in the upper base cover.

3. The heating apparatus as claimed in claim 1, wherein the heating member is a PTC (positive temperature coefficient) heating member.

4. The heating apparatus as claimed in claim 1, wherein a plurality of rubber pads are provided under the lower base cover.
